(19) United States
(12) Patent Application Publication
(10) Pub. No.: US 2024/0126948 A1
(43) Pub. Date: Apr. 18, 2024

(54) NUMERICAL SIMULATION OPTIMIZATION METHOD OF IMPACT DAMAGE BASED ON LASER MAPPED SOLID MESH

(71) Applicant: NANJING UNIVERSITY OF AERONAUTICS AND ASTRONAUTICS, Nanjing (CN)

(72) Inventors: Xu JIA, Nanjing (CN); Yingdong SONG, Nanjing (CN); Rong JIANG, Nanjing (CN); Dawei WANG, Nanjing (CN)

(73) Assignee: NANJING UNIVERSITY OF AERONAUTICS AND ASTRONAUTICS, Nanjing, JS (CN)

(21) Appl. No.: 18/275,730

(22) PCT Filed: Dec. 29, 2022
(86) PCT No.: PCT/CN2022/143082

§ 371 Date: Aug. 3, 2023

(30) Foreign Application Priority Data
Jan. 5, 2022 (CN) 202210006738.3

(51) Int. Cl. G06F 30/23; G06T 17/20; G06F 111/10; G06F 119/02

(52) U.S. Cl. CPC G06F 30/23; G06T 17/20; G06F 2111/10; G06F 2119/02

(57) ABSTRACT

A numerical simulation optimization method of impact damage based on a laser mapped solid mesh is provided, including: measuring an impact damage size, a damage profile, a surface residual strain and a surface residual stress of a solid mesh element around the damage after firing a bullet by a light gas gun to impact a mesh area of a sample and obtaining the impact damage; establishing a parameterized impact finite element model to obtain a numerically simulated impact damage size, a numerically simulated impact damage profile, a numerically simulated surface residual strain and the surface residual stress of the surface solid mesh element; and calculating relative errors between the experimental measurements and the numerically simulated impact damage size, damage profile, surface residual strain and residual stress; and determining whether the relative errors are all less than expected values until a numerical simulation result meeting the accuracy requirements are obtained.

### CROSS-REFERENCE TO RELATED APPLICATION

This patent application claims the benefit and priority of Chinese Patent Application No. 2022100067383 filed to China National Intellectual Property Administration on Jan. 5, 2022 and entitled as “NUMERICAL SIMULATION OPTIMIZATION METHOD OF IMPACT DAMAGE BASED ON LASER MAPPED SOLID MESH”, the entire content of which is incorporated by reference in the present application.

### TECHNICAL FIELD

The present disclosure belongs to the technical field of impact damage reproduction, impact damage tolerance and maintainability evaluation of aero-engine blades, in particular to a numerical simulation optimization method of impact damage based on a laser mapped solid mesh.

### BACKGROUND

During take-off and landing of an aircraft, an aero-engine often inhales hard objects such as pebbles, grits and metals, which impact the engine fan/compressor blades, resulting in impact damage such as pits, notches, tears and scratches, which are one of the main factors that decrease the fatigue strength of blades, shorten the fatigue life of blades and make the blades break prematurely in the service cycle. Therefore, it is necessary to evaluate the impact damage tolerance and maintainability of damaged blades. Impact damage often has a significant stress concentration and a residual stress, which has a serious impact on the fatigue performance of damaged blades.

At present, the distribution of the surface residual stress can be measured by a residual stress measuring device, but it is almost impossible to directly measure the complete distribution of the internal residual stress at present. The material cost and the time cost for testing the internal residual stress by an exfoliation corrosion method is high, which cannot meet the engineering requirements. Therefore, the numerical simulation method with the help of finite element software such as ANSYS Ls-dyna or Abaqus has become an effective means to obtain the distribution of the internal residual stress of material impact damage. However, since the actual impact process is dispersive, for example, the attitude of the bullet and the position of the bull's-eye are different from the nominal experimental parameters, and this difference has a significant impact on the geometric morphology and the residual stress of impact damage, the error between the numerical simulation result under the nominal impact condition and the experimental result is often large. At the same time, the failure strain in the material model not only has a great influence on the numerical simulation results, but also is difficult to be obtained accurately by experimental methods. Therefore, it is difficult to obtain accurate residual stress values by the existing numerical simulation method of impact damage, and even the distribution form is far from the actual results. Therefore, the existing methods have met the requirements for fatigue performance prediction of impact damage. Therefore, a method is needed to improve numerical simulation accuracy of an impact damage geometry and an internal residual stress.

### SUMMARY

The present disclosure aims to provide a numerical simulation optimization method of impact damage based on a laser mapped solid mesh with the notch size, the profile, the residual stress and the residual strain after impact damage as constraint variables, so as to solve the problem of numerical simulation accuracy of an impact damage geometry and an internal residual stress.

In order to achieve the above purpose, the present disclosure provides the following technical solutions.

A numerical simulation optimization method of impact damage based on a laser mapped solid mesh, including the following steps:
step 1, including mapping a finite element mesh, by using laser etching, after scaling up, onto a surface of a to-be-impacted area of a sample to form a surface solid mesh element, and measuring an impact damage size, a damage profile, a surface residual strain and a surface residual stress of the solid mesh element around an impact damage after firing a bullet by a light gas gun to impact a mesh area of the sample, and obtaining the impact damage;
step 2, including establishing a parameterized impact finite element model by a finite element software, setting material model parameters of the bullet and the sample, solving, upon defining constraints, to obtain a numerically simulated impact damage size, a numerically simulated impact damage profile, numerically simulated surface residual strain and surface residual stress of the surface solid mesh element;
step 3, including calculating relative errors between the impact damage size, the damage profile, the surface residual strain and the residual stress from experimental measurement and numerically simulated impact damage size, damage profile, surface residual strain and residual stress; and
step 4, including determining whether the relative errors in step 3 are all less than expected values, if exceeding the expected values, changing an optimization variable including an impact parameter, a material model parameter and a mesh size parameter, and repeating step 1 to step 3 until a numerical simulation result meeting accuracy requirements is obtained.

Optionally, in step 1, a sample physical surface mesh in the to-be-impacted area has the same shape and direction as those of a sample solid surface mesh in a finite element, both being quadrilateral mesh, with sizes in relationship of multiples; the solid mesh has a line width, a line spacing and a line direction, is obtained by laser etching, with etching depth not more than 0.1 mm, after etching, elements of the solid mesh and intersection points of scribed lines are numbered according to coordinates.

Optionally, in step 1, a light gas gun is adopted to fire a bullet with a specified shape and a specified size at a set impact angle and a set impact velocity, the shape of the bullet including a sphere, a square and a cylinder, to impact a specified position of a sample solid mesh area, to obtain the impact damage, the impact damage including pits and notches.

Optionally, in step 1, the surface residual strain of the physical surface mesh element around the impact damage is obtained by a non-contact digital image-related measurement system by comparing deformation of the physical surface mesh before and after impact; the surface residual stress of the physical surface mesh element around the impact damage is obtained by measuring a residual stress value of each node position by a micro-area X-ray stress meter and then calculating an arithmetic average; a geometric size of the impact damage is measured by a digital optical microscope, and the geometric size of the impact damage includes a damage depth, a damage length and a damage width.

Optionally, in step 2, the established parameterized impact finite element model includes a finite element mesh model of the bullet and the sample, an attitude of the bullet and a position of the bullet with respect to the sample, and the defined constraints include an impact velocity and an impact angle.

Optionally, in step 3, the relative error between the damage profiles is expressed as:

$$SIM = \frac{1}{{N}_{del}^{t}} {\sum }_{i = 1}^{{N}_{del}^{t}} ( \frac{{n}_{i}^{s}}{{n}_{e}} {n}_{i} - 1 )$$

where N_{del}^{t} is the number of physical surface elements with material loss due to impact damage obtained by experiment, which is obtained by counting numbering and quantity after an impact experiment; nₑ is the number of elements for finite element contained in the physical surface element, nᵢ^{s} is a number of element deletion for finite element within a range of an i-th physical surface elements with material loss; in a case that the solid mesh is completely lost and corresponding finite element mesh is completely deleted, the ratio nᵢ^{s} to nₑ is 1, and the smaller the SIM value is, the closer a numerically simulated residual mesh profile after mesh loss is to an actual impact damage profile.

Optionally, in step 3, the relative error between the impact damage sizes in cases of the solid mesh and the finite element mesh with proportional relationship is expressed as:

$${δ}_{si𝓏e} = \sqrt{{( \frac{{d}_{1}^{s} - {d}_{1}^{t}}{{d}_{1}^{t}} )}^{2} + {( \frac{{d}_{2}^{s} - {d}_{2}^{t}}{{d}_{2}^{t}} )}^{2} + … + {( \frac{{l}_{1}^{s} - {l}_{1}^{t}}{{l}_{1}^{t}} )}^{2} + … ( \frac{{w}_{1}^{s} - {w}_{1}^{t}}{{w}_{1}^{t}} ) + …}$$

where d₁^{s} and d₂^{s} are depths of the impact damage in different positions simulated by the finite element, d₁^{t} and d₂^{t} are depths of the impact damage in different positions obtained by experiment, l₁^{s} is a length of the impact damage simulated by the finite element, l₁^{s} is a length of the impact damage obtained by experiment, w₁^{s} is a width of the impact damage simulated by the finite element, w₁^{t} is a width of the impact damage obtained by experiment, and δ_{size} is the relative error.

Optionally, in step 3, the relative error between the surface residual strains on a mesh surface of the impact damage in cases of the solid mesh and the finite element mesh, and the relative error between the residual stresses on the mesh surface of the impact damage in cases of the solid mesh and the finite element mesh, are respectively denoted as:

$${δ}_{R ε} = \sqrt{{( \frac{{ε}_{1}^{s} - {ε}_{1}^{t}}{{ε}_{1}^{t}} )}^{2} + {( \frac{{ε}_{2}^{s} - {ε}_{2}^{t}}{{ε}_{2}^{t}} )}^{2} + … + {( \frac{{ε}_{n}^{s} - {ε}_{n}^{t}}{{ε}_{n}^{t}} )}^{2}}$$

$${δ}_{R σ} = \sqrt{{( \frac{{σ}_{1}^{s} - σ}{{σ}_{1}^{t}} )}^{2} + {( \frac{{σ}_{2}^{s} - {σ}_{2}^{t}}{{σ}_{2}^{t}} )}^{2} + … + … {( \frac{{σ}_{n}^{s} - {σ}_{n}^{t}}{{σ}_{n}^{t}} )}^{2}}$$

where, elements for measuring the surface residual strain and the surface residual stress only include elements in a strip-shaped area with the radius ranging from 1 time to twice a maximum damage depth, n is a number of surface elements in the strip-shaped area; ε₁^{s}, ε₂^{s} . . . εₙ^{s} and σ₁^{s}, σ₂^{s} . . . σₙ^{s} are numerically simulated residual strain and numerically simulated residual stress of the finite element mesh element of the impact damage, respectively, ε₁^{t}, ε₂^{t} . . . εₙ^{t} and σ₁^{t}, σ₂^{t} . . . σₙ^{t} are the residual strain and the residual stress of the solid mesh element of the impact damage obtained by experiment, respectively, δ_{Rε} is the relative error between the residual strains on the mesh surface of the impact damage; and δ_{Rσ} is the relative error between the residual stresses on the mesh surface of the impact damage.

Optionally, the impact parameter includes a bullet attitude parameter and a bullet position parameter with respect to the sample, the material model parameter includes a failure strain parameter, and the mesh size parameter includes a ratio of a size of the physical surface mesh element to a size of the finite element mesh element.

The present disclosure has the following beneficial effects.

The present disclosure provides a numerical simulation optimization method of impact damage based on a laser mapped solid mesh, which provides a reasonable and standardized optimization method and process for numerical simulation calculation of impact damage of aero-engine blades. The core idea is to associate a finite element numerical model with a real solid model through a laser mapped mesh, which can also avoid the problem that impact causes the mesh to fall off, and enable calibration of the numerical simulation result of the finite element based on the measured result of impact experiment. According to the present disclosure, by combining the impact experiment measuring means and the finite element analysis method, adjusting calculation parameters according to relative errors between the residual profiles, the surface residual strains and the residual stresses to calibrate the numeral simulation result, the problem of the numerical simulation accuracy of the impact damage geometry and the internal residual stress can be solved, which is beneficial to further evaluating and determining the impact damage tolerance and the maintainability thereof.

### BRIEF DESCRIPTION OF THE DRAWINGS

In order to explain the embodiments of the present disclosure or the technical schemes in the prior art more clearly, the drawings that need to be used in the embodiments will be briefly introduced. Obviously, the drawings in the following description are only some embodiments of the present disclosure. For those skilled in the art, other drawings can be obtained according to these drawings without creative labor.

FIG. 1 is a schematic diagram of the proportional relationship between a solid mesh and a finite element mesh.

FIG. 2 is a picture of a physical object of solid mesh by laser etching of a to-be-impacted area of a titanium alloy sample.

FIG. 3 is a schematic diagram of impacting the position of bull's-eye.

FIG. 4 is a diagram of comparison between a size of impact damage obtained by experiment and a size of impact damage obtained by digital simulation.

FIG. 5 is a schematic diagram of elements with material loss and a profile of impact damage.

FIG. 6 is a schematic diagram of an area where a surface residual strain and a residual stress are measured.

FIG. 7 is a schematic diagram of the adjustment of a bullet body attitude and the position of a bull's-eye.

### DETAILED DESCRIPTION OF THE EMBODIMENTS

The technical solutions in the embodiments of the present disclosure will be clearly and completely described with reference to the drawings in the embodiments of the present disclosure hereinafter. Apparently, the described embodiments are only some embodiments of the present disclosure, rather than all of the embodiments. Based on the embodiments of the present disclosure, all other embodiments obtained by those skilled in the art without creative labor fall within the scope of protection of the present disclosure.

The present disclosure relates to a numerical simulation optimization method of impact damage based on a laser mapped solid mesh, including the following steps 1-4.

In step 1, upon being scaled up, a finite element mesh is mapped, by using laser etching, onto a surface of a to-be-impacted area of a sample to form a surface solid mesh element, and then a light gas gun fires bullet to impact a mesh area of the sample, to obtain an impact damage, and size of the impact damage (including a damage depth, a damage length and a damage width), a damage profile, a surface residual strain and a surface residual stress of the solid mesh element around the damage are measured.

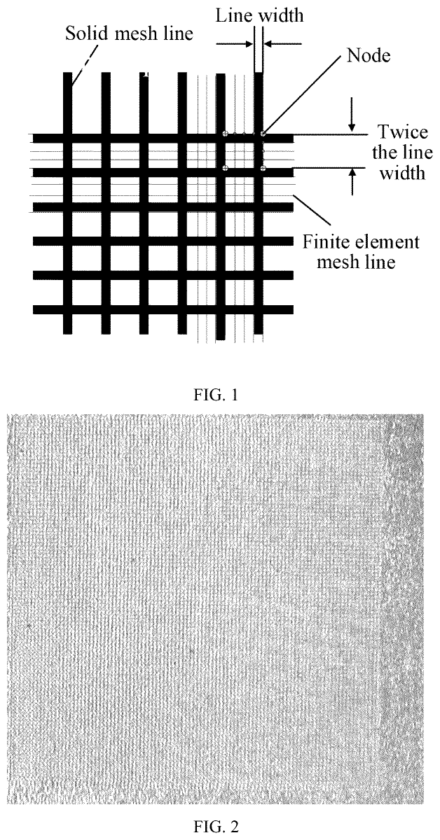

A laser marking machine is used to perform high-energy etching on the to-be-impacted area of the sample to obtain a solid mesh, and the etching depth is not more than 0.1 mm. The elements and nodes (intersection points of scribed lines) of the solid mesh are numbered according to coordinates. The solid mesh has a certain line width, a line spacing and a line direction, which is a proportional mapping of the element mesh for finite element. That is, the sample physical surface mesh has the same shape and direction as those of the solid model surface finite element mesh, and the sizes have a relationship of multiples, and as shown in FIG. 1, in this embodiment, the size of the solid mesh is twice the width of the laser scribed line. The solid mesh obtained by high-energy etching a to-be-impacted area of a TC4 titanium alloy flat sample by using a laser marking machine is as shown in FIG. 2.

Thereafter, a spherical GCr13 bearing steel bullet with a typical impact velocity of 300 m/s and a diameter of 2 mm is fired by a light gas gun, to impact the to-be-impacted area of the leading edge plate sample at the most dangerous impact angle of 60 degree to obtain notch-type impact damage. The geometric sizes of notch-type damage including the damage depth, the damage length and the damage width are measured by a digital optical microscope. The solid mesh elements are numbered according to step 1. The numbering of the solid mesh lossed in the notch-type damage area and the mesh residual profile after the solid mesh loss in the notch-type damage area are observed and recorded by using a digital optical microscope. The deformation of the solid mesh before and after impact is compared by a non-contact digital image-related measurement system, to obtain a surface residual strain of the remaining meshes around the notch; the surface residual stress of the solid mesh is measured by a micro-area X-ray stress meter.

In step 2, the method includes establishing a parameterized impact finite element model (including the finite element mesh model of the bullet and the sample, the bullet attitude and the position of the bullet with respect to the sample) by the finite element software, setting material model parameters of the bullet and the sample, solving, upon defining constraints (including an impact velocity and an impact angle), to obtain a numerically simulated impact damage size, a numerically simulated impact damage profile, numerically simulated surface residual strain and surface residual stress of the surface solid mesh element.

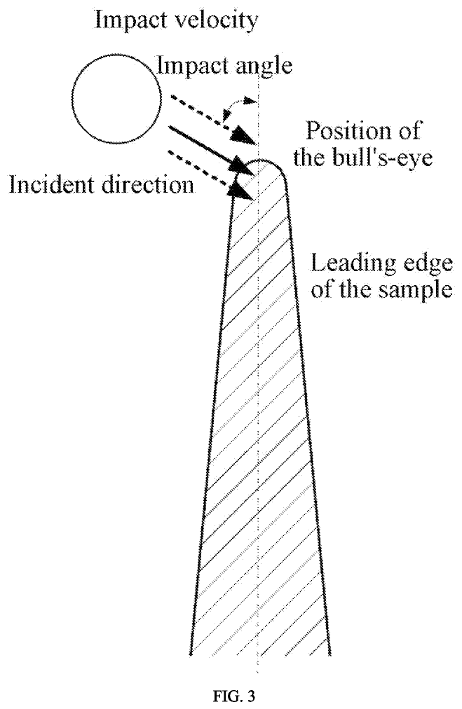

The impact model of the sample and the bullet is modeled by an APDL module of ANSYS software, including modeling of the geometric model of the sample, the geometric model of the bullet, the attitude of the bullet (such as the position of sides and angles of the block projectile with respect to the coordinate system) and the position where the ballistic trajectory calculated according to the impact angle and impact velocity of the bullet falls on the surface of the sample (the position of the bull's-eye, as shown in FIG. 3). According to the proportional mapping relationship of the laser mapped solid mesh in step 1, the sample model is divided into meshes, and the mesh type is of hexahedral elements. Generally, because the laser scribed line has a certain width, the density of the solid mesh is generally lower than that of the finite element mesh. In this embodiment, the size of the solid mesh is four times that of the finite element mesh, as shown in FIG. 1. By adopting a BAMMAN viscoplastic constitutive model (which can well simulate the plastic deformation and failure process of metal under a large strain and a high strain rate), and setting the material model parameters (including failure strain ε_{f}), numerical solving for the finite element is carried out, so as to obtain the mesh residual profile, the mesh surface residual strain and the surface residual stress data after the finite element mesh loss by the impact damage.

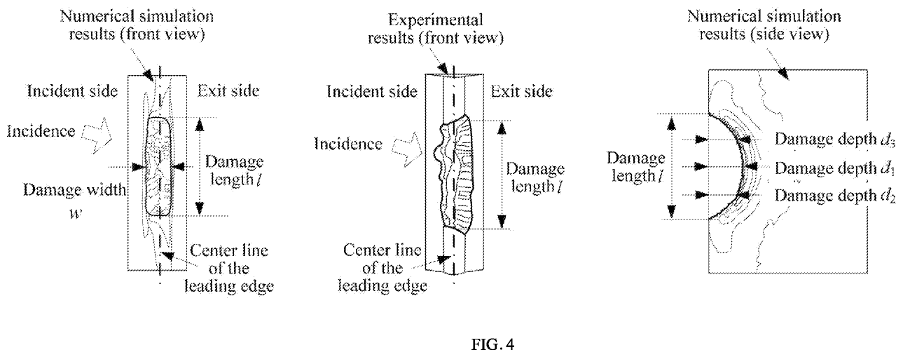

In step 3, relative errors between the experimental measurements and the numerical simulated impact damage size, the damage profile, the surface residual strain and the residual stress are calculated. A relative error between the impact damage sizes in two cases of the solid mesh (experiment) and the finite element mesh (numerical values) with proportional relationship is calculated as:

$${δ}_{si𝓏e} = \sqrt{{( \frac{{d}_{1}^{s} - {d}_{1}^{t}}{{d}_{1}^{t}} )}^{2} + {( \frac{{d}_{2}^{s} - {d}_{2}^{t}}{{d}_{2}^{t}} )}^{2} + … + {( \frac{{l}_{1}^{s} - {l}_{1}^{t}}{{l}_{1}^{t}} )}^{2} + … ( \frac{{w}_{1}^{s} - {w}_{1}^{t}}{{w}_{1}^{t}} ) + …}$$

where d₁^{s} and d₂^{s} are depths of impact damage in different positions in finite element simulation, d₁^{t} and d₂^{t} are depths of impact damage in different positions obtained by experiment, l₁^{s} is the length of impact damage in finite element simulation, l₁^{t} is the length of impact damage obtained by experiment, w₁^{s} is the width of impact damage in the finite element simulation, w₁^{t} is the width of impact damage obtained by experiment, and δ_{size} is the relative error. The comparison between the size of the impact damage obtained by experiment and the size of the impact damage obtained by the numerical simulation is shown in FIG. 4, including the front view and side view of the numerical simulation result and the front view of the experiment result. For the front view, there is an incident side and an exit side (divided by the center line of the leading edge), and the damage length l of the exit side is measured. For the side view, since the damage produces an arc-shaped impact, the damage length l, the damage depth d₁, the damage depth d₂ and the damage depth d₃ can be measured.

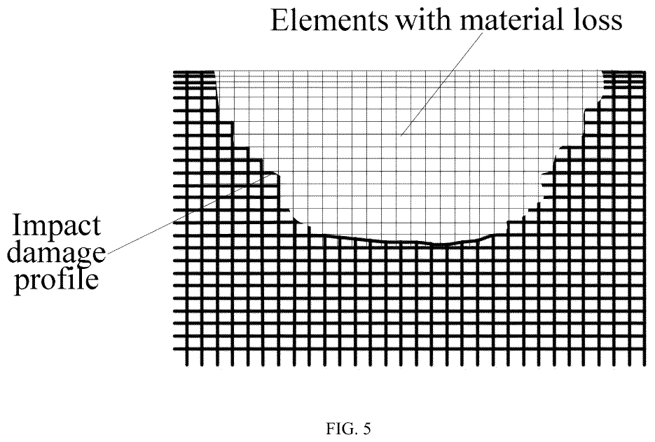

A relative error between the residual profiles after the mesh loss by the impact damage in cases of the solid mesh (by experiment) and the finite element mesh (by numerical value) is calculated as:

$$SIM = \frac{1}{{N}_{del}^{t}} {\sum }_{i = 1}^{{N}_{del}^{t}} ( \frac{{n}_{i}^{s}}{{n}_{e}} {n}_{i} - 1 )$$

where N_{del}^{t} is the number of elements on physical surface with material loss due to impact damage obtained by experiment (obtained by counting their numberings and quantity after the impact experiment); nₑ is the number of elements for finite element contained in a physical surface element, nᵢ^{s} is the number of element deletion for finite element within the range of the i-th physical surface element with material loss; in the case that the solid mesh is completely lost and the corresponding finite element mesh is completely deleted, the ratio of nᵢ^{s} to nₑ is 1, and the smaller the SIM value is, the closer the residual mesh profile after the numerical simulated mesh loss is to the actual impact damage profile. Elements with material loss and the impact damage profile are shown in FIG. 5.

Relative error between the residual strains and relative error between the residual stresses on the mesh surface of the impact damage in cases of the solid mesh (by experiment) and the finite element mesh (by numerical values) are respectively calculated as:

$${δ}_{R ε} = \sqrt{{( \frac{{ε}_{1}^{s} - {ε}_{1}^{t}}{{ε}_{1}^{t}} )}^{2} + {( \frac{{ε}_{2}^{s} - {ε}_{2}^{t}}{{ε}_{2}^{t}} )}^{2} + … + {( \frac{{ε}_{n}^{s} - {ε}_{n}^{t}}{{ε}_{n}^{t}} )}^{2}}$$

$${δ}_{R σ} = \sqrt{{( \frac{{σ}_{1}^{s} - σ}{{σ}_{1}^{t}} )}^{2} + {( \frac{{σ}_{2}^{s} - {σ}_{2}^{t}}{{σ}_{2}^{t}} )}^{2} + … + … {( \frac{{σ}_{n}^{s} - {σ}_{n}^{t}}{{σ}_{n}^{t}} )}^{2}}$$

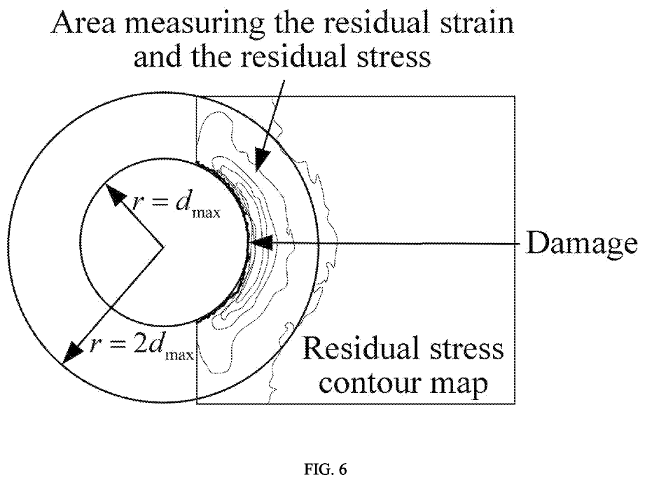

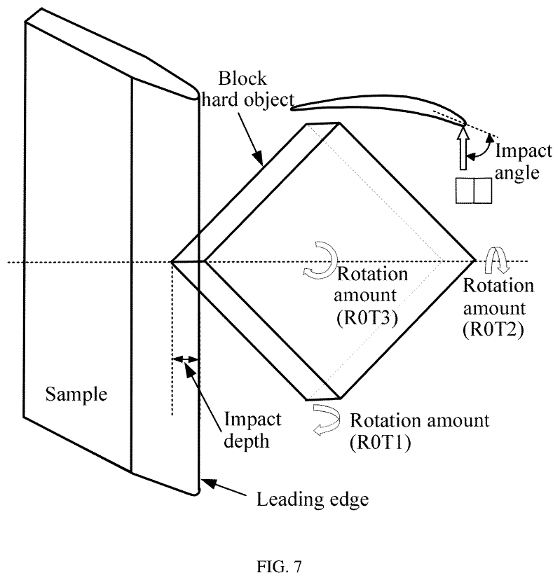

The closer to the damage bottom, the more serious the extrusion and accumulation of surface materials are. The farther away from the damaged bottom, the smaller the residual stress caused by impact is. Therefore, the area selected for measuring the surface residual strain and the residual stress is limited. In this embodiment, the elements for measuring the surface residual strain and the surface residual stress only include the elements in a strip-shaped area with the radius ranging from 1 time to twice the maximum damage depth, as shown in FIG. 6. In the above formula, n is the number of surface elements in the strip-shaped area. ε₁^{s}, ε₂^{s} . . . εₙ^{s} and σ₁^{s}, σ₂^{s} . . . σₙ^{s} are numerically simulated residual strains and numerically simulated residual stresses of the finite element mesh element of impact damage, respectively, ε₁^{t}, ε₂^{t} . . . εₙ^{t} and σ₁^{t}, σ₂^{t} . . . σₙ^{t} are the residual strains and the residual stresses of the solid mesh element of impact damage obtained by experiment, respectively, δ_{Rε} is the relative error between the residual strains on the mesh surface of the impact damage; and δ_{Rσ} is the relative error between the residual stresses on the mesh surface of the impact damage.

In step 4, it is determined whether the relative errors in step 3 are all less than expected values. If exceeding the expected values, optimization variables are changed, including impact parameters, material model parameters and mesh size parameters, and the above steps are repeated until a numerical simulation result meeting the accuracy requirements is obtained.

It is determined whether the relative errors between the residual profiles, the mesh surface residual strains and the residual stresses after mesh loss due to impact damage in step 3 are less than the expected value, which is 10% in this embodiment. If the relative errors are not less than the expected value, the numerically simulated impact parameters (including the attitude of the bullet and the position of the bull's-eye, as shown in FIG. 7), material model parameters (including failure strain) and mesh size parameters (including the ratio of the size of the solid mesh to the size of the finite element mesh) in step 2 are changed. The above steps are repeated, until a numerical simulation results meeting the accuracy requirements is obtained.

In this specification, various embodiments are described in a progressive way. Each embodiment focuses on differences from other embodiments, and the same and similar parts of various embodiments can be referred to each other.

In the present disclosure, specific examples are adopted to illustrate the principle and implementation of the present disclosure, and the explanations of the above embodiments are only for helping understand the method and core ideas of the present disclosure. Modification in specific embodiments and application areas are possible based on the idea of the disclosure, to those skilled in the art. In summary, the contents of the specification should not be construed as limiting the present invention.

1. A numerical simulation optimization method of impact damage based on a laser mapped solid mesh, comprising the following steps:
step 1, mapping a finite element mesh, by using laser etching, after scaling up, onto a surface of a to-be-impacted area of a sample to form a surface solid mesh element, and measuring, after firing a bullet by a light gas gun to impact a mesh area of the sample and obtain the impact damage, an impact damage size, a damage profile, a surface residual strain and a surface residual stress of the solid mesh element around an impact damage;
step 2, establishing a parameterized impact finite element model by a finite element software, setting material model parameters of the bullet and the sample, defining constraints to solve, to obtain a numerically simulated impact damage size, a numerically simulated impact damage profile, numerically simulated surface residual strain and surface residual stress of the surface solid mesh element;
step 3, calculating relative errors between the impact damage size, the damage profile, the surface residual strain and the residual stress from experimental measurement and the numerically simulated impact damage size, the numerically simulated damage profile, the numerically simulated surface residual strain and the numerically simulated residual stress; and
step 4, determining whether the relative errors in step 3 are all less than expected values, if exceeding the expected values, changing an optimization variable comprising an impact parameter, the material model parameter and a mesh size parameter, and repeating step 1 to step 3 until a numerical simulation result meeting accuracy requirements is obtained.

2. The numerical simulation optimization method of impact damage based on the laser mapped solid mesh according to claim 1, wherein in step 1, a sample physical surface mesh in the to-be-impacted area has same shape and direction as those of a sample solid surface mesh for finite element, both being quadrilateral mesh, with sizes in relationship of multiples; the solid mesh has a line width, a line spacing and a line direction, is obtained by laser etching, with etching depth not more than 0.1 mm, and after etching, elements of the solid mesh and intersection points of scribed lines are numbered according to coordinates.

3. The numerical simulation optimization method of impact damage based on the laser mapped solid mesh according to claim 1, wherein in step 1, a light gas gun is adopted to fire a bullet with a specified shape and a specified size at a set impact angle and a set impact velocity, the shape of the bullet comprising a sphere, a square and a cylinder, to impact a specified position of a sample solid mesh area, to obtain the impact damage, the impact damage comprising pits and notches.

4. The numerical simulation optimization method of impact damage based on the laser mapped solid mesh according to claim 1, wherein in step 1, the surface residual strain of the physical surface mesh element around the impact damage is obtained by a non-contact digital image-related measurement system through comparing deformation of the physical surface mesh before and after impact; the surface residual stress of the physical surface mesh element around the impact damage is obtained through measuring a residual stress value of each node position by a micro-area X-ray stress meter and then calculating an arithmetic average; a geometric size of the impact damage is measured by a digital optical microscope, and the geometric size of the impact damage comprises a damage depth, a damage length and a damage width.

5. The numerical simulation optimization method of impact damage based on the laser mapped solid mesh according to claim 1, wherein in step 2, the established parameterized impact finite element model comprises a finite element mesh model of the bullet and the sample, an attitude of the bullet and a position of the bullet with respect to the sample, and the defined constraints comprise an impact velocity and an impact angle.

6. The numerical simulation optimization method of impact damage based on the laser mapped solid mesh according to claim 1, wherein in step 3, the relative error of the damage profile is expressed as:
$$SIM = \frac{1}{{N}_{del}^{t}} {\sum }_{i = 1}^{{N}_{del}^{t}} ( \frac{{n}_{i}^{s}}{{n}_{e}} {n}_{i} - 1 )$$
wherein N_{del}^{t} is a number of physical surface elements with material loss due to impact damage obtained by experiment, which is obtained by counting serial numbers and quantity of the physical surface elements after an impact experiment; nₑ is a number of elements for finite element contained in the physical surface element, nᵢ^{s} is a number of deleted element for finite element within a range of an i-th physical surface elements with material loss; in a case that the solid mesh is completely lost and corresponding finite element mesh is completely deleted, the ratio of nᵢ^{s} to nₑ is 1, and as the SIM value is small, a numerically simulated residual mesh profile after mesh loss is close to an actual impact damage profile.

7. The numerical simulation optimization method of impact damage based on the laser mapped solid mesh according to claim 1, wherein in step 3, the relative error between the impact damage sizes in cases of the solid mesh and the finite element mesh with proportional relationship is calculated as follows:
$${δ}_{si𝓏e} = \sqrt{{( \frac{{d}_{1}^{s} - {d}_{1}^{t}}{{d}_{1}^{t}} )}^{2} + {( \frac{{d}_{2}^{s} - {d}_{2}^{t}}{{d}_{2}^{t}} )}^{2} + … + {( \frac{{l}_{1}^{s} - {l}_{1}^{t}}{{l}_{1}^{t}} )}^{2} + … ( \frac{{w}_{1}^{s} - {w}_{1}^{t}}{{w}_{1}^{t}} ) + …}$$
wherein d₁^{s} and d₂^{s} are depths of the impact damage in different positions simulated by the finite element, d₁^{t} and d₂^{t} are depths of the impact damage in different positions obtained by experiment, l₁^{s} is a length of the impact damage simulated by the finite element, l₁^{t} is a length of the impact damage obtained by experiment, w₁^{s} is a width of the impact damage simulated by the finite element, w₁^{t} is a width of the impact damage obtained by experiment, and δ_{size} is the relative error.

8. The numerical simulation optimization method of impact damage based on the laser mapped solid mesh according to claim 1, wherein in step 3, the relative error between the surface residual strains of elements around the impact damage in cases of the solid mesh and the finite element mesh, and the relative error between the residual stresses of the elements around the impact damage in cases of the solid mesh and the finite element mesh, are respectively expressed as:
$${δ}_{R ε} = \sqrt{{( \frac{{ε}_{1}^{s} - {ε}_{1}^{t}}{{ε}_{1}^{t}} )}^{2} + {( \frac{{ε}_{2}^{s} - {ε}_{2}^{t}}{{ε}_{2}^{t}} )}^{2} + … + {( \frac{{ε}_{n}^{s} - {ε}_{n}^{t}}{{ε}_{n}^{t}} )}^{2}}$$
$${δ}_{R σ} = \sqrt{{( \frac{{σ}_{1}^{s} - σ}{{σ}_{1}^{t}} )}^{2} + {( \frac{{σ}_{2}^{s} - {σ}_{2}^{t}}{{σ}_{2}^{t}} )}^{2} + … + … {( \frac{{σ}_{n}^{s} - {σ}_{n}^{t}}{{σ}_{n}^{t}} )}^{2}}$$
wherein, elements for measuring the surface residual strain and the surface residual stress only comprise elements in a strip-shaped area with a radius ranging from 1 time to twice a maximum damage depth, n is a number of surface elements in the strip-shaped area; ε₁^{s}, ε₂^{s} . . . εₙ^{s} and σ₁^{s}, σ₂^{s} . . . σₙ^{s} are numerically simulated residual strain and numerically simulated residual stress of the finite element mesh elements around the impact damage, respectively, ε₁^{t}, ε₂^{t} . . . εₙ^{t} and σ₁^{t}, σ₂^{t} . . . σₙ^{t} are the residual strain and the residual stress of the solid mesh elements around the impact damage obtained by experiment, respectively, δ_{Rε} is the relative error of the surface residual strains of the mesh around the impact damage; and δ_{Rσ} is the relative error of the surface residual stresses of the mesh around the impact damage.

9. The numerical simulation optimization method of impact damage based on the laser mapped solid mesh according to claim 1, wherein the impact parameter comprises a bullet attitude parameter and a bullet position parameter with respect to the sample, the material model parameter comprises a failure strain parameter, and the mesh size parameter comprises a ratio of a size of the physical surface mesh element to a size of the finite element mesh element.
